(19) United States
(12) Patent Application Publication
(10) Pub. No.: US 2009/0153443 A1
(43) Pub. Date: Jun. 18, 2009

(54) PLASMA DISPLAY DEVICE AND METHOD OF DRIVING THE SAME

(75) Inventors: Seungwon CHOI, Yongin-si (KR); Seongjoon Jeong, Yongin-si (KR); Woojoon Chung, Yongin-si (KR); Sukjae Park, Yongin-si (KR)

Correspondence Address: STEIN MCEWEN, LLP, 1400 EYE STREET, NW, SUITE 300, WASHINGTON, DC, 20005, US

(73) Assignee: Samsung SDI CO., LTD., Suwon-si (KR)

(21) Appl. No.: 12/333,671

(22) Filed: Dec. 12, 2008

(30) Foreign Application Priority Data
Dec. 14, 2007 (KR) 2007-131357

(51) Int. Cl. G09G 3/28

(52) U.S. Cl. 345/68

(57) ABSTRACT

A plasma display device including: a display panel including discharging cells; a driving unit that supplies a reset signal, an address signal, and a sustain signal to the discharging cells; and a logic controller that controls the driving unit. The driving unit includes a scan driver for generating the reset signal. The scan driver supplies a falling ramp pulse and step pulses to reset the discharge cells. The logic controller supplies a switch control signal to the scan driver, to control the generation of the step pulses.

### CROSS-REFERENCE TO RELATED APPLICATION

This application claims priority to and the benefit of Korean Patent Application No. 2007-131357, filed on Dec. 14, 2007, in the Korean Intellectual Property Office, the entire disclosure of which is incorporated herein, by reference.

### BACKGROUND OF THE INVENTION

1. Field of the Invention

Aspects of the present invention relate to a plasma display device and a method of driving the same.

2. Description of the Related Art

In recent years, many kinds of flat display devices have been developed and marketed. These flat display devices include liquid crystal display devices, field emission display devices, and plasma display devices.

A plasma display device can display digital images by creating a plasma discharge, and can be formed to have a larger screen size than the other flat display devices. A plasma display device includes a discharge system that includes two substrates and an inert gas sealed between the two substrates. When a voltage is applied between the two substrates, a plasma discharge is generated in the gas, and ultra-violet radiation is produced and then used to produce visible light.

In a plasma display device, one frame is divided into a plurality of sub-fields that have different light-emission frequencies, so as to realize the various gray levels of a picture. Each sub-field is divided into several periods, and driving signals are supplied during each of the periods. In general, one sub-field is divided into a reset period, an address period, and a sustain period. In the reset period, discharging cells, formed in a display panel of the plasma display device, are initialized. The initialized discharging cells are divided into display discharging cells and non-display discharging cells, during the address period. The display discharging cell produce a display discharge, during the sustain period.

During the address period, an address driver and a scan driver respectively supply address signals and scan signals to the discharging cells. The address driver and the display panel are generally connected to each other by a cable having a driving chip, or by a film-type tape carrier package (TCP). The driving chip plays an important role in transmitting the address signals. The driving chip transmits a larger amount of driving signals and generates a larger amount of heat than the driving chips provided in other driving units. The driving chip is also expensive. Therefore, a technique for reducing the amount of heat generated by the driving chip, to prevent damage to the driving chip, is needed.

In order to reduce the amount of heat generated by the driving chip, driving signals having a low voltage can be supplied. However, low voltage driving signals can cause an erroneous discharge or a low discharge, which result in a reduction in the display quality of a plasma display device. In addition, when the driving signals are supplied with a discharge delay, in order to prevent the erroneous discharge, the sustain period for display discharge is shortened, which results in a reduction in display quality. For this reason, driving signals are needed, which can stably perform an address discharge, while effectively reducing the amount of heat generated by the driving chip.

### SUMMARY OF THE INVENTION

An aspect of the present invention is to provide a plasma display device and a method of driving the same, which can stably performing high-speed addressing at a low voltage, without reducing display quality.

According to one aspect of the present invention, a plasma display device includes: a display panel including discharging cells; a driving unit that supplies a reset signal, an address signal, and a sustain signal to the discharging cells, which includes a scan driver for generating the reset signal; and a logic controller that controls the driving unit. In the plasma display device, the reset signal includes a falling ramp pulse and step pulses. The logic controller supplies a switch control signal to the scan driver, to selectively control the application of the step pulses.

According to aspects of the present invention, the reset signal may be a main reset signal, including a rising ramp pulse applied during a set-up period and the falling pulse applied during a set-down period.

According to aspects of the present invention, the reset signal may be a sub-reset signal, including the falling pulse that gradually falls from a sustain voltage of the sustain signal, after the sustain signal is supplied.

According to aspects of the present invention, the falling pulse may include: a first period, in which a scan voltage of a scan signal is reduced at a first gradient, by falling ramp pulse; and a second period that succeeds the first period, during which the step pulses are applied.

According to aspects of the present invention, the falling ramp pulse and the step pulses may have different voltage gradients.

According to aspects of the present invention, the scan driver may include: a first supply unit that supplies the falling ramp pulse during the first period; and a second supply unit that supplies the step pulses during the second period.

According to aspects of the present invention, the first supply unit may include: a first switch that selectively connects a first power supply to the display panel; and a falling ramp controller that controls the first switch, to generate the falling ramp pulse.

According to aspects of the present invention, the second supply unit may include: a second switch that selectively connect the first power supply to the display panel; and a step pulse controller that controls the on/off state of the second switch, to generate the step pulses.

According to aspects of the present invention, the first power supply may supply the scan voltage.

According to another aspect of the invention, there is provided a method of driving a plasma display device, by using driving signals that each have a reset period. The method includes: supplying a first voltage to a scan electrode; supplying a falling ramp pulse that falls from the first voltage, at a first gradient; and supplying step pulses having a second gradient after the supply of the falling ramp pulse.

According to aspects of the present invention, the supplying of the first voltage may include: applying a rising ramp pulse to the scan electrode, which gradually rises from the first voltage; and returning the voltage of the scan electrode to the first voltage, from a peak voltage of the rising ramp pulse.

According to aspects of the present invention, the supplying of the first voltage may include: applying the first voltage to the scan electrode, to supply a sustain signal for a sustain discharge among the driving signals; and maintaining the voltage of the scan electrode at the first voltage.

According to aspects of the present invention, the supplying of the falling ramp pulse may include: generating a control signal to turn on or off a first switch that supplies a second voltage to the display panel.

According to aspects of the present invention, the supplying of the step pulses may include: generating a control signal to turn on or off a second switch that supplies a second voltage to a display panel of the plasma display device.

According to aspects of the present invention, the supplying of the step pulses may include: varying a switch-on period or a switch-off period of the control signal, to change the second gradient.

According to aspects of the present invention, a minimum voltage of the step pulses may be at least the second voltage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a diagram illustrating the arrangement of electrodes and drivers in a plasma display device, according to an exemplary embodiment of the invention;

FIG. 2 is a diagram illustrating driving signals for driving the plasma display device, according to an exemplary embodiment of the invention;

FIG. 3 is a diagram illustrating a driving signal in a reset period shown in FIG. 2;

FIG. 4 is a circuit diagram illustrating a driving circuit of a scan driver, according to an exemplary embodiment of the invention; and

FIG. 5 is a diagram illustrating the waveform of a driving pulse, including a sub-reset period, during which step pulses are applied.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

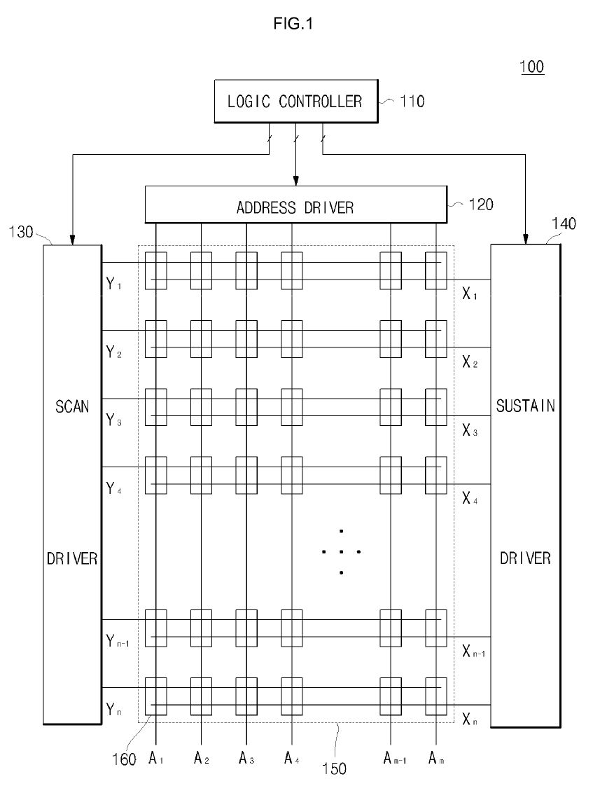

FIG. 1 is a diagram illustrating the arrangement of electrodes and connection of drivers in a plasma display device 100, according to an exemplary embodiment of the invention. As shown in FIG. 1, the plasma display device 100 includes a logic controller 110, an address driver 120, a scan driver 130, a sustain driver 140, and a display panel 150. While shown as a single scan-type display panel, it is understood that the present invention is not limited to structure of the plasma display device shown in FIG. 1.

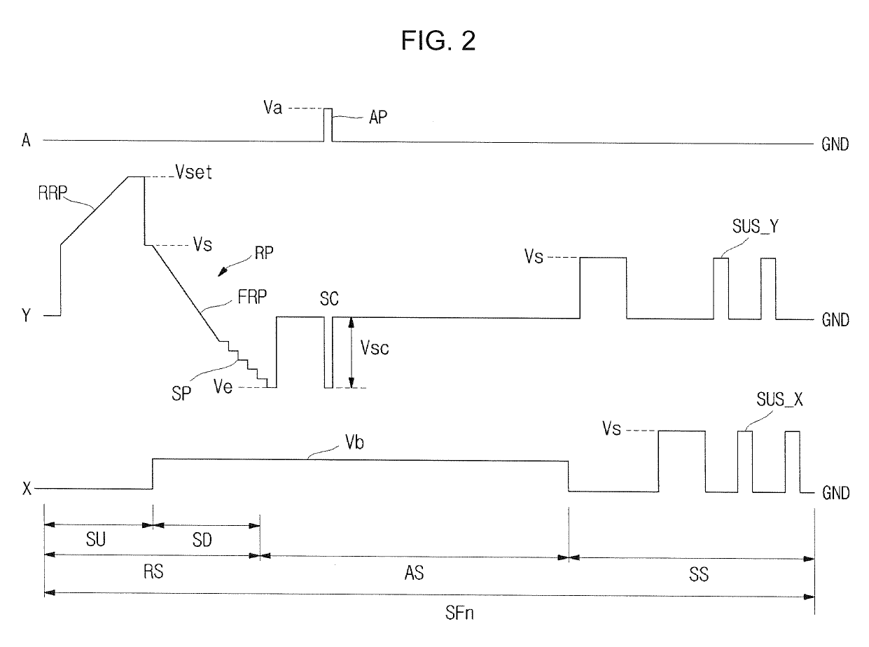

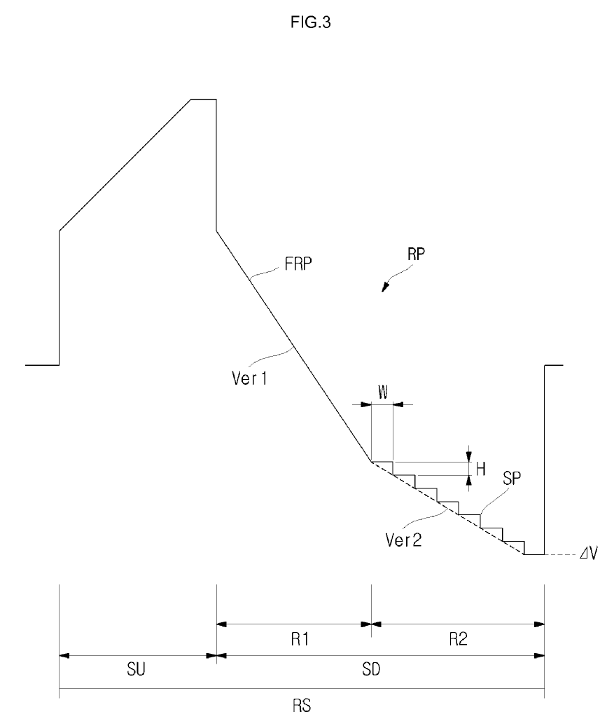

The logic controller 110 converts image signals transmitted from an image processor, or externally provided image signals, into data that can be processed by the drivers 120, 130, and 140. The logic controller 110 transmits data and controls the application of signals to the drivers 120, 130, and 140, to control the drivers 120, 130, and 140. In particular, the logic controller 110 controls the scanning driver 130, to apply a falling pulse (reset pulse RP) comprising falling ramp pulse FRP and step pulses SP, during a reset period RS. The step pulses SP will be described below in more detail, with reference to FIGS. 2 and 3.

The address driver 120 receives data and control signals from the logic controller 110, and supplies address pulses AP to address electrodes A (A1 to Am) of the display panel 150. Discharging cells 160 are selected for discharging, by the address pulses AP. In a selective write mode, the selected discharging cells perform the display discharge during an address period AS. In a selective erase mode, the non-selected discharging cells perform the display discharge during the address period AP.

The scan driver 130 receives data and control signals from the logic controller 110. The scan driver 130 supplies reset pulses RP, scan pulses SC, and sustain pulses SUS to scan electrodes Y (Y1 to Yn) of the display panel 150. The scan driver 130 supplies a rising ramp pulse RRP, a falling ramp pulse, and the step pulses SP, during the reset period RS. The scan driver 130 supplies the scan pulses SC during the address period AS, in synchronization with the address pulse AP. The scan driver 130 supplies sustain pulses SUS_Y during a sustain period SS. In particular, the scan driver 130 supplies the falling ramp pulse FRP and the step pulses SP to the display panel 150, under the control of the logic controller 110, to perform high-speed addressing, while stably performing an address discharge. That is, the step pulses SP reduce the amount of visible light generated by a discharge caused by the reset pulse RP. As a result, wall charges are efficiently erased, and thus, an address voltage is lowered, making it possible to remarkably reduce the amount of heat generated by a connection member, which will be described in more detail with reference to FIGS. 2 and 3.

The sustain driver 140 supplies sustain pulses SUS_X in response to the data and control signals transmitted from the logic controller 110. In this exemplary embodiment, the scan driver 130 and the sustain driver 140 supply the sustain pulses SUS_X, but the present invention is not limited thereto. For example, only the scan driver 130 may supply the sustain pulses. When only the scan driver 130 supplies the sustain pulses, the sustain driver 140 may be integrated with the scan driver 130, which will be described later, in more detail.

The display panel 150 receives the driving signals supplied from the address driver 120, the scan driver 130, and the sustain driver 140, to display images. In order to display images, the address electrodes A, the scan electrodes Y, and sustain electrodes X are formed on the display panel 150. The address driver 120 is arranged on one side of the display panel 150. The address electrodes A and the address driver 120 are connected to each other, by a connection member, for example, a tape carrier package. The address electrodes A are formed in one direction, for example, in a vertical direction of the display panel 150. The scan electrodes Y and the sustain electrodes X are formed on the display panel 150 in a second direction, so as to intersect the address electrodes A. The scan electrodes Y and the sustain electrodes X are respectively connected to the scan driver 130 and the sustain driver 140, by connection members. The discharging cells 160 are formed at intersections between the address electrodes A, the scan electrodes Y, and the sustain electrodes X.

FIG. 2 is a diagram illustrating an example of a driving signal used to drive the plasma display device, according to an exemplary embodiment of the invention. Referring to FIG. 2, the driving signal, which is supplied to the display panel Cp, is divided into the reset period RS, the address period AS, and the sustain period SS. The reset period RS can be further divided into a set-up period SU and a Set-down period SD.

During the reset period RS, a reset pulse RP is applied to the scan electrodes Y. The reset pulse RP can be divided into a rising ramp pulse RRP, a falling ramp pulse FRP, and step pulses SP. The rising ramp pulse RRP is applied to the scan electrode Y, and a ground voltage GND is applied to the sustain electrode X and the address electrode A, during the set-up period SU. A dark discharge is generated between the scan electrode Y and the electrodes X and A in each discharging cell 160, by the rising ramp pulse RRP. Immediately after the set-up period SU, the dark discharge causes positive wall charges to remain on the address electrode A and the sustain electrode X, and negative wall charges to remain on the scan electrode Y.

The falling ramp pulse FRP is applied to the scan electrode Y, during the set-down period SD, which is subsequent to the set-up period SU. At the same time, a positive bias voltage Vb is applied to the sustain electrode X, and a ground voltage (GND) is applied to the address electrode A. The dark discharge is generated between the scan electrode Y and the address electrode X in each discharging cell 160, by the falling ramp pulse FRP, so that an excessive amount of wall charge generated in the set-up period SU is adjusted to an amount of wall charge necessary for an address discharge. Therefore, the distribution of wall charge in the discharging cell 160 is changed, so as to be suitable for the address discharge.

The step pulses SP are applied during the end of the set-down period SD. The voltages of the step pulses SP start from a voltage level lower than the ground voltage GND and are then lowered to an erase voltage Ve. The erase voltage Ve may be equal to a scan voltage Vsc, which will be described later. The erase voltage Ve may vary. The step pulses SP make it possible to supply the scan voltage Vsc at a low level, which makes it possible to lower the potential of the address pulse AP. As a result, a low scan voltage Vsc can be applied, which makes it possible to smoothly generate the address discharge, without a discharge delay. Thus it is possible to drive the plasma display device at a high speed and at a low address voltage Va. The step pulses SP make it possible to increase the length of the reset period RS, so as to prevent an erroneous discharge, and improve the stability of the address discharge, which will be described later in more detail with reference to FIG. 3.

During the address period AS, a negative scan pulse SC is supplied to the scan electrode Y, and the address pulse AP is supplied in synchronization with the scan pulse SC. The discharging cells 160 are selected by the address pulse AP and the scan pulse SC. In this exemplary embodiment, the voltage Va of the address pulse AP is lower than the address voltage of the related art. In this way, the address driver 120, particularly, a driving chip of the tape carrier package, can process the address pulse AP having a low address voltage. As a result, heat generated by the address driver is reduced, and the address driver can be stably driven. Meanwhile, a bias voltage Vb can be continuously supplied to the sustain electrode X, during the address period AS, as well as during the set-down period SD.

The sustain pulses SUS_Y and X have a positive sustain voltage Vs and are alternately applied to the scan electrode Y and the sustain electrode X, during the sustain period SS. Therefore, the selected discharging cells 160 perform a display discharge, during the address period AS.

FIG. 3 is a diagram illustrating the reset pulse RP shown in FIG. 2. Referring to FIG. 3, the address voltage Va and the scan voltage Vsc are lower than those of the related art. Therefore, the plasma display device and a method of driving the same, according to the exemplary embodiments of the invention, can perform high-speed addressing, at a low address voltage Va.

More specifically, a discharge is generated when the difference between a wall charge voltage and the voltage the falling ramp pulse FRP is higher than a discharge voltage in a portion of the set-down period SD. During the set-down period SD, the voltage applied to the scan electrode is reduced, during the reset period RS, as shown in FIG. 3. When discharge is generated, the reduction rate of the wall charge voltage is approximately equal to that of the falling ramp pulse FRP. In this case, the difference between the wall charge voltage and the voltage formed by the falling ramp pulse FRP is maintained, at a sufficient level to generate the discharge, and thus, the discharge is continuously generated. Therefore, most of the wall charges, except the wall charges necessary for the address discharge, are erased, and the discharging cell is initialized.

However, the internal environments of the discharging cells 160 that have performed the display discharge in a previous sub-field are different from that of the discharging cells that have not performed the display discharge in the previous sub-field. This difference affects the address discharge, which causes a problem, in that no discharging cell is selected, or in that unnecessary discharging cells are selected. In addition, the distribution of wall charges in the discharging cells 160 becomes non-uniform, which makes it necessary to increase the address voltage or the scan voltage of the scan pulse SC.

When only the scan pulse SC is supplied to generate the address discharge, the discharge delay increases. Therefore, the address pulse AP is supplied together with the scan pulse SC, in order to minimize the discharge delay. When the difference between the voltage of the address pulse AP and the voltage of the scan pulse SC is higher than a firing voltage, the address discharge is generated. The lower the voltage Vsc of the scan pulse SC, the lower the voltage Va of the address pulse AP. That is, as the voltage Vsc of the scan pulse SC decreases, it is possible to minimize the amount of heat generated by the tape carrier package transmitting the address pulse AP.

However, the higher the voltage Vsc of the scan pulse SC, the longer the discharge delay becomes, resulting in an increase in erroneous discharges. It is useful to increase the width of the reset period RS, particularly, the set-down period SD, and to lower the low-level voltage Ve (erase voltage) of the falling ramp pulse FRP, in order to prevent the erroneous discharge. In addition, it is useful to adjust the gradient of the falling ramp pulse FRP, to make the internal environment of the discharging cell suitable for the address discharge, and to minimize the amount of light emitted.

Therefore, in this exemplary embodiment of the invention, the falling ramp pulse FRP and the step pulses SP of the reset pulse RP have different gradients. As shown in FIG. 3, the set-down period SD is divided into a first period R1, in which the falling ramp pulse FRP has a first gradient Ver1, and a second period R2, in which the step pulses SP have a second gradient Ver2.

The first gradient Ver1 may be equal, to or different from, the second gradient Ver2, according to operational conditions. For example, the second gradient Ver2 may be higher than the first gradient Ver1, in order to increase the amount of wall charges to be erased. On the other hand, the second gradient Ver2 may be lower than the first gradient Ver1, in order to decrease the amount of wall charges to be erased. That is, the first and second gradients Ver1 and Ver2 depend on the characteristics of a particular plasma display device.

More specifically, the wall charges generated in the set-up period SU are erased in the set-down period SD. In this case, the voltage of the wall charges is lower than the voltage of the falling ramp pulse FRP, during a portion of the first period R1. Thereafter, when the potential of the falling ramp pulse FRP is lowered, and the difference between the voltage of the wall charges and the voltage of the falling ramp pulse FRP is higher than the firing voltage, the wall charges are recombined and energy is discharged. The discharge causes the reduction rate of the voltage of the wall charges to be substantially equal to that of the voltage of the falling ramp pulse FRP. That is, the discharge causes the gradient of the voltage reduction of the wall charges to be equal to the first gradient Ver1. In this case, the gradient of the second period R2 is adjusted to be less than that of the first period R1, in order to preserve some of the wall charges.

The timing of the second period R2 may be adjusted arbitrarily. For example, the second period R2 may begin when the falling ramp pulse FRP ends. When the reset pulse RP has the second gradient Ver2, in the second period R2, an erase discharge stops, or is reduced, because the gradient of the reset pulse RP is lower than a voltage reduction gradient of the wall charges. In this case the wall charges are not completely erased. The remaining wall charges assist the address discharge, in a subsequent address period AS.

On the other hand, when a large amount of energy remains in the discharging cells 160, due to the continuous display of high gray-level data in a previous frame, the erase rate of the wall charges can be increased, in order to prevent an erroneous discharge. In this case, the second gradient Ver2 is adjusted to be larger than the first gradient Ver1, in order to increase the rate at which the wall charges are removed.

It is possible to easily adjust the second gradient Ver2, by adjusting the width W and the height H of the step pulses. That is, it is possible to supply the step pulses, by selectively supplying power during the second period R2. In this case, the width W is a power-off period, and the height H is a power-on period.

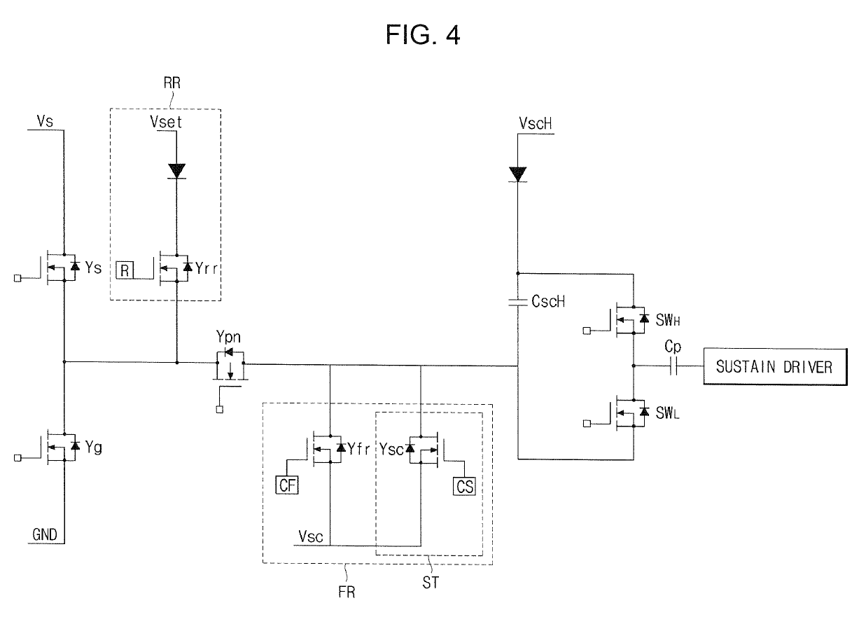

This selective application of power will be described in more detail with reference to FIG. 4. FIG. 4 is a circuit diagram illustrating the structure of a driving circuit of the scan driver, according to an exemplary embodiment of the invention. The present invention is not limited to the driving circuit shown in FIG. 4. The driving circuit will be described with reference to FIGS. 2 and 3, as well as FIG. 4.

Referring to FIG. 4, when the set-up period SU starts, a sustain switch Ys, a node switch Ypn, and a low switch SWL are turned on, and a sustain voltage (a first voltage) Vs is applied to the panel Cp. At this time, a rising ramp switch Yrr is turned on, under the control of a rising ramp pulse supply unit RR, and a reset voltage Vset is applied to the panel Cp. Then, the rising ramp pulse RRP is supplied to the panel Cp. Thereafter, when the set-down period SD starts, the rising ramp switch Yrr is turned off, to cutoff the supply of the reset voltage Vset, and the sustain switch Ys is turned off, to cutoff the supply of the sustain voltage Vs.

Then, a first supply unit FR turns on a falling ramp switch Yfr (first switch), to supply the scan voltage Vsc (second voltage), which is a reset voltage, to the panel Cp, and the falling ramp pulse FRP is supplied to the panel Cp. The first supply unit FR includes a falling ramp controller CF to control the falling ramp switch Yfr. A scan switch Ysc (second switch) is switched on by a second supply unit ST, such that pulses having the second gradient Ver2 are supplied to the panel Cp. The second supply unit ST includes a step pulse controller CS to control the scan switch Ysc. In this case, a separate power supply is not used to supply power to the panel Cp, through the scan switch Ysc, but the scan voltage Vsc is supplied to the panel Cp through the scan switch Ysc. The scan voltage Vsc is generated by the first power supply.

In this exemplary embodiment, instead of the falling ramp switch Yfr and the scan switch Ysc, only one switch may be used to supply the step pulses SP. However, a large amount of load is applied to the one switch, and thus, generally both the falling ramp switch Yfr and the scan switch Ysc are used, as shown in FIG. 2.

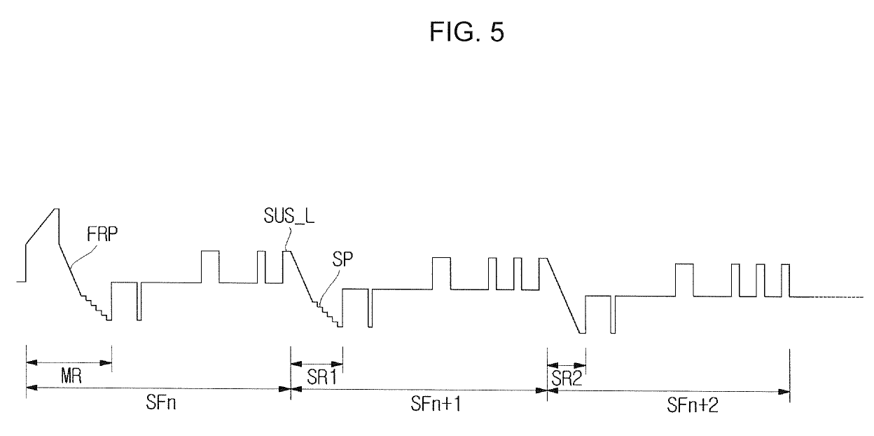

FIG. 5 is a waveform diagram illustrating a driving waveform including sub-reset periods having the step pulses SP. A continuous series of three sub-fields is shown in FIG. 5, and a main reset period and sub-reset periods are included in the three sub-fields.

As shown in FIG. 5, the step pulses SP can be applied during a sub-reset period SR1, and a main reset period MR. In the sub-reset period SR1, a voltage, having the same waveform as the falling ramp pulse FRP of the main reset period MR, is applied immediately after the last sustain pulse SUS_L, to initialize the discharging cells. Therefore, the falling ramp pulse FRP can be applied to the sub-reset period SR1, as well as the main reset period MR. In particular, it is advantageous that the step pulses SP are selectively applied to a sub-field SFn+1, which has a high gray level. In the sub-field SFn+1, an excessively large amount of wall charges may be generated.

The sub-reset period SR1 serves as a set-up period SU of the main reset period MR, in the sub-field SFn+1, which makes it unnecessary to additionally provide the set-up period SU in the sub-field SFn+1. Therefore, the sub-reset period SR1, not the main reset period MR, is provided after the display discharge in the sub-field SFn+1, to initialize the discharging cells, as in the main reset period MR. In particular, as the gray value becomes larger, a larger amount of wall charge are generated in the sub-reset period SR1, as compared to the set-up period of the main reset period MR. Therefore, an erase pulse plays an important role in the generation of wall charges, and thus, the falling ramp pulse FRP and the step pulses SP are applied during the sub-field SFn+1.

The reset pulse RP having the step pulses SP may be applied to all of the sub-reset periods SR. However, it is generally preferable to apply the reset pulse RP comprising the step pulses SP to only the sub-fields SFn and SFn+i that have high gray values, as shown in FIG. 5, but the present invention is not limited thereto. Therefore, according to aspects of the present invention, a reset waveform including step pulses is used, which makes it possible to stably perform high-speed addressing, at a low voltage, without deteriorating display quality.

Although the exemplary embodiments of the invention have been described above, the invention is not limited thereto. Therefore, it would be appreciated by those skilled in the art that various modifications and changes of the invention can be made, without departing from the scope and spirit of the invention, the scope of which is defined in the appended claims and their equivalents.

What is claimed is:

1. A plasma display device comprising:
a display panel comprising discharging cells;
a driving unit to supply a reset signal, an address signal, and a sustain signal to the discharging cells, the driving unit comprising a scan driver to generate the reset signal; and
a logic controller to control the driving unit and to control the generation of the step pulses by the scan driver,
wherein the reset signal comprises a falling ramp pulse and step pulses.

2. The plasma display device as claimed in claim 1, wherein:
the reset signal is a main reset signal further comprising a rising ramp pulse that is applied during a set-up period; and
the falling ramp pulse and the step pulses are applied in a set-down period.

3. The plasma display device as claimed in claim 1, wherein the reset signal is a sub-reset signal comprising the falling pulse, which gradually falls from a sustain voltage of the sustain signal, after the sustain signal is supplied.

4. The plasma display device as claimed in claim 2, wherein:
a scan voltage of a scan signal is reduced at a first gradient, during a first period, by the falling ramp pulse; and
the scan voltage is then incrementally reduced at a second gradient, during a second period, by the step pulses.

5. The plasma display device as claimed in claim 4, wherein the first and second gradients are not equal.

6. The plasma display device as claimed in claim 5, wherein the scan driver comprises:
a first supply unit to supply the falling ramp pulse; and
a second supply unit to supply the step pulses.

7. The plasma display device as claimed in claim 6, wherein the first supply unit comprises:
a first switch to selectively connect a first power supply and the display panel; and
a falling ramp controller to control the first switch.

8. The plasma display device as claimed in claim 6, wherein the second supply unit comprises:
a second switch to selectively connect the first power supply and the display panel; and
a step pulse controller to control the second switch, so as to control generation of the step pulses.

9. The plasma display device as claimed in claim 7, wherein the first power supply supplies a scan voltage.

10. A method of driving a plasma display device, comprising:
applying a sustain voltage to a scan electrode;
reducing the sustain voltage at a first gradient, using a falling ramp pulse; and
incrementally reducing the reduced sustain voltage to an erase voltage, at a second gradient, using step pulses.

11. The method of driving a plasma display device as claimed in claim 10, wherein the supplying of the first voltage comprises:
applying a reset voltage to the scan electrode, using a rising ramp pulse; and
reducing the reset voltage to the sustain voltage.

12. The method of driving a plasma display device as claimed in claim 10, wherein the supplying of the sustain voltage comprises:
applying the sustain voltage to the scan electrode, so as to produce a sustain discharge.

13. The method of driving a plasma display device as claimed in claim 11, wherein the supplying of the falling ramp pulse comprises generating a control signal for turning on or off a first switch, so as to selectively supply the erase voltage to the scan electrode.

14. The method of driving a plasma display device as claimed in claim 13, wherein the step pulses are generated by selectively connecting a voltage source to the scan electrode, using a second switch.

15. The method of driving a plasma display device as claimed in claim 14, wherein the selectively connecting of the voltage source comprises varying the time the second switch is opened and closed, so as to vary the second gradient.

16. The method of driving a plasma display as claimed in claim 15, wherein the erase voltage is not less than the voltage of the voltage source.

17. A method of driving a plasma display device, the method comprising:
applying a main reset pulse to scan electrodes of the plasma display device, the application of the reset pulse comprising,
applying a sustain voltage to the scan electrodes,
applying a rising ramp pulse to the scan electrodes, so as to apply a reset voltage to the scan electrodes,
decreasing the voltage of the scan electrodes to the sustain voltage,
applying a falling ramp pulse to the scan electrodes, so as to reduce the sustain voltage to a first voltage, at a first gradient, and
applying step pulses to the scan electrodes, so as to incrementally reduce the first voltage to an erase voltage, at a second gradient.

18. The method of claim 17, further comprising:
applying a first sub-reset pulse to the scan electrodes, the application of the sub-reset pulse comprising,
applying the sustain voltage to the scan electrodes,
applying a falling ramp pulse to the scan electrodes, so as to reduce the sustain voltage to the first voltage, at the first gradient, and
applying step pulses to the scan electrodes, so as to incrementally reduce the first voltage to the erase voltage, at the second gradient.

19. The method of claim 18, further comprising:
applying a second sub-reset pulse to the scan electrodes, the application of the second sub-reset pulse comprising,
reapplying the sustain voltage to the scan electrodes; and
applying a falling ramp pulse to the scan electrodes, so as to reduce the sustain voltage to the erase voltage.

20. The method of claim 17, wherein the first and second gradients are not equal.
